(19) United States
(12) Patent Application Publication
(10) Pub. No.: US 2006/0015586 A1
(43) Pub. Date: Jan. 19, 2006

(54) Simplifying connection establishment in systems accessing other systems via redundant addressable gateways

(76) Inventors: Manish Sharma, Bangalore (IN); Alexendar Chernoguzov, Warrington, PA (US); Indra Banerjee, Plymouth Meeting, PA (US); Benoy Joseph, Bangalore (IN); Rajani Keerthiveetil, Bangalore (IN)

Correspondence Address: HONEYWELL INTERNATIONAL INC., 101 COLUMBIA ROAD, P O BOX 2245, MORRISTOWN, NJ, 07962-2245, US

(21) Appl. No.: 10/861,553

(22) Filed: Jun. 4, 2004

(51) Int. Cl. G06F 15/177

(52) U.S. Cl. 709/220

(57) ABSTRACT

According to an aspect of the present invention, any of the redundant gateways selected to operate as an active gateway, is configured to be accessible by a pre-specified address. As a result, any systems communicating with other systems via a gateway may use the same pre-specified address to access the other system irrespective of which of the redundant gateways is operating as an active gateway. The implementation of systems is simplified as a result.

### BACKGROUND OF INVENTION

1. Field of the Invention

The present invention generally relates to network communication, and more specifically to a method and apparatus for simplifying connection establishment in systems accessing other systems via redundant addressable gateways.

2. Related Art

A gateway generally refers to a device which enables connectivity to be established between systems operating in a heterogenous environment. Gateways are often provided to enable communication between disparate networks (e.g., token ring vs. Ethernet), disparate applications (e.g., file transfers implemented using different protocols), etc.

Gateways are often implemented to be addressable (i.e., can be accessed by an address). A system on one side of the gateway may send data to another system via a gateway using the address of the gateway, as is well known in the relevant arts.

Environments often include multiple redundant gateways, primarily for reliability. That is, even if one of the gateways becomes non-operational (non-accessible), redundancy may be provided to enable the systems to communicate with each other using the other (redundant) gateway(s).

In one-prior approach, each of the redundant gateways is provided a different address (e.g., different IP address), and the systems are required to send the data to the available (usable) ones of the redundant gateways. In such an approach, if a system is presently communicating with a first one of the gateways and the first gateway becomes non-operational, the system needs to send data thereafter to the other gateways using the corresponding different addresses.

One problem with such an approach is that each of the systems may need to have the ‘intelligence’ to recognize whether a gateway is usable, and forward data through an usable gateway. In other words, if one of the presently usable gateways becomes non-operational, the systems forwarding via such a gateway may need to dynamically recognize the non-accessibility of the gateway and use one of the remaining redundant gateways.

The complexity of implementation on several systems, and the overhead associated with the dynamic recognition may be unacceptable at least in some environments. What is therefore desirable is a method and apparatus for simplifying connection establishment in systems accessing other systems via redundant addressable gateways.

### SUMMARY OF INVENTION

An aspect of the present invention simplifies the implementation of a first system accessing other systems via an active gateway, wherein the active gateway corresponds to any one of a multiple redundant gateways. In one embodiment, the first system is configured to communicate with the active gateway using a pre_specified address and the specific gateway selected to operate as the active gateway is configured to be accessible by the pre_specified address. As a result, the first system can access the other systems via any active gateway using the same pre-specified address.

According to another aspect of the present invention, if an active gateway becomes non-operational, another one of the redundant gateways is dynamically configured to be accessible by the same pre-specified address. As a result, the first system may continue to access the other systems using the same pre-specified address.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF DRAWINGS

The present invention will be described with reference to the accompanying drawings which are described briefly below.

FIG. 1 is a block diagram of an example environment in which several aspects of the present invention can be implemented.

FIG. 2 is a flow-chart illustrating the manner in which a system may communicate with other systems using any of the redundant gateways using a pre-specified address according to an aspect of the present invention.

FIG. 3 is a flow-chart illustrating a manner in which another redundant gateway takes on the role of an active gateway if the present active gateway becomes non-operations in an embodiment of the present invention.

FIG. 4 is a flow-chart illustrating a manner in which a primary gateway (initialized ahead of secondary gateway) may take the role of an active gateway in one embodiment.

FIG. 5 is a flow-chart illustrating a manner in which a secondary gateway (initialized ahead of primary gateway) may take on the role of an active gateway in one embodiment.

FIG. 6 is a block diagram illustrating the details of a primary and secondary gateway implemented in an embodiment.

FIG. 7 is a block diagram illustrating a software implementation of a gateway in one embodiment.

### DETAILED DESCRIPTION

### 1. Overview

According to an aspect of the present invention, communication is implemented between redundant gateways to enable one of the gateways to be determined as an active gateway. The active gateway is configured to be accessible by a pre-specified address. If the active gateway becomes non-operational for whatever reason, another one of the redundant gateways is determined to be an active gateway and configured with the pre-specified address (after the pre-specified address is dropped by an active gateway that becomes non-operational). As a result, all the systems designed to communicate via one of the redundant gateways may be implemented to communicating using the single (pre-specified) address, and thus the implementation of the systems may be simplified.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

### 2. Example Environment

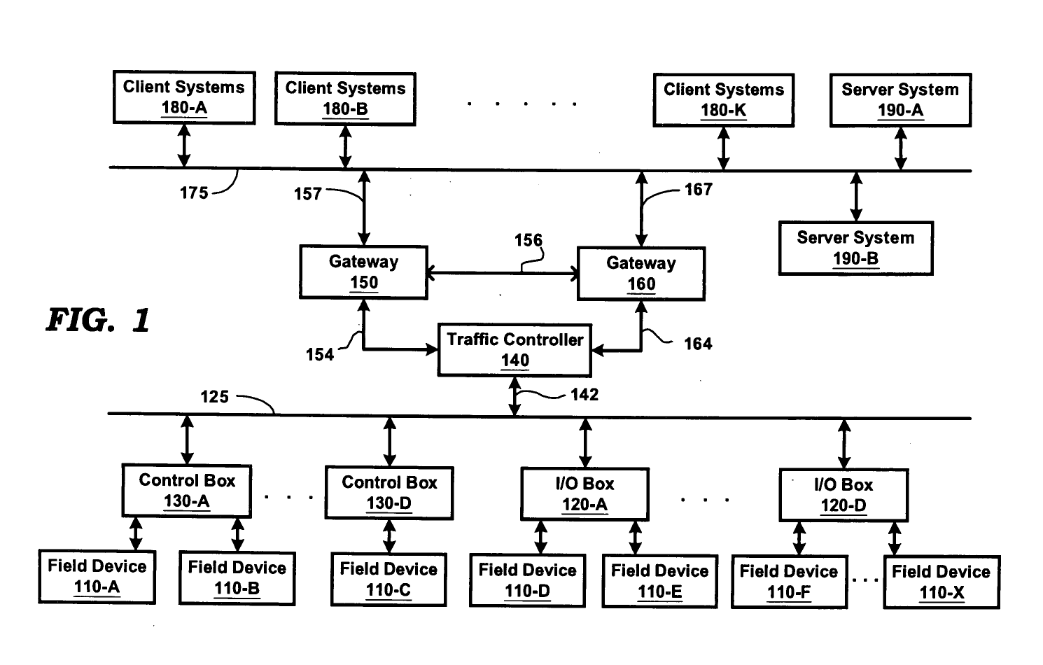

FIG. 1 is a block diagram of an example manufacturing environment in which several aspects of the present invention can be implemented. Environment 100 is shown containing field devices 110_A through 110_X, I/O blocks 120_A through 120_C, control boxes 130_A through 130_C, traffic controller 140, processing systems 150 and 160, client systems 180_A through 180_K, and servers 190-A and 190-B. Each block is described below in further detail.

For illustration and conciseness, example environment 100 is shown containing few client systems, two processing systems 150 and 160 that can operate as gateways. However, a typical environment may contain several blocks of each of the above type as well as other types. Several aspects of present invention may be implemented in other environments as well.

Field devices 110_A through 110_X generally represent components such as sensors (which measure various variables such as temperature, flow, pressure, etc.), control elements (e.g.,valves, switches) and transmitters. For conciseness, various aspects of the present invention are described in a scenario in which each field device responds to queries received from client systems via one of the gateways. However, field devices may perform other tasks to support a manufacturing process, and various aspects of the present invention may be applicable in such tasks as well. Field devices 110_A through 110_X may be implemented in a known way.

Each of I/O blocks 120-A through 120-D forwards data to traffic controller 140 or one of the corresponding field devices depending on the target address to which the data is to be forwarded. The commands (from a client system) may be forwarded to a corresponding field device 110-D through 110-X and the data received from field devices in response may be sent to a traffic controller 140.

Each of control boxes 130-A through 130-D receives data from corresponding field devices (e.g., sensors), processes the data in a pre_defined manner (e.g., according to a control algorithm) and generates a control signal. The control signal is then used to operate another field device (e.g., to open/close a control valve).

Traffic controller 140 receives data from one of processing systems and forwards the data to a corresponding I/O or control boxes depending on a target/destination address typically contained in the data. The data received from I/O or control boxes may be forwarded to a corresponding processing system operating as a gateway. I/O blocks, control boxes, traffic controller are connected to process network 125. I/O blocks 120-A through 120-D, control boxes 130-A through 130-D, and traffic controller 140 may be implemented in a known way.

Servers 190-A and 190-B provide a repository for storing and providing various configuration data such as IP address to be used by gateways (as described below in further detail), process parameters (used to configure various control loops), and various data received from field devices (e.g., alarms).Servers 190-A and 190-B are shown connected to communication network 175 (e.g., Ethernet). Servers 190-A and 190-B may be implemented in a known way.

Client systems 180-A through 180-K represent digital processing systems which support applications (e.g., related to configuration, operation, and control of processes implemented) that may communicate with other systems/devices. Each of client systems 180-A through 180-K (connected to network 175) communicates with field devices 110-A through 110-X via one of the gateways 150 and 160.

Gateways 150 and 160 are implemented to provide redundancy, and only one of the gateways may be an active gateway at any instance of time. In an embodiment, the gateways operate to connect networks operating with different network protocols and media, and thus the packet payload is transferred without any modification. An aspect of the present invention enables each of client systems 180-A through 180-K to be configured with a single address, and communicate with the field devices regardless of which one of gateways 150/160 is a presently active gateway, as described below in further detail.

### 3. Simplifying Implementation of Systems

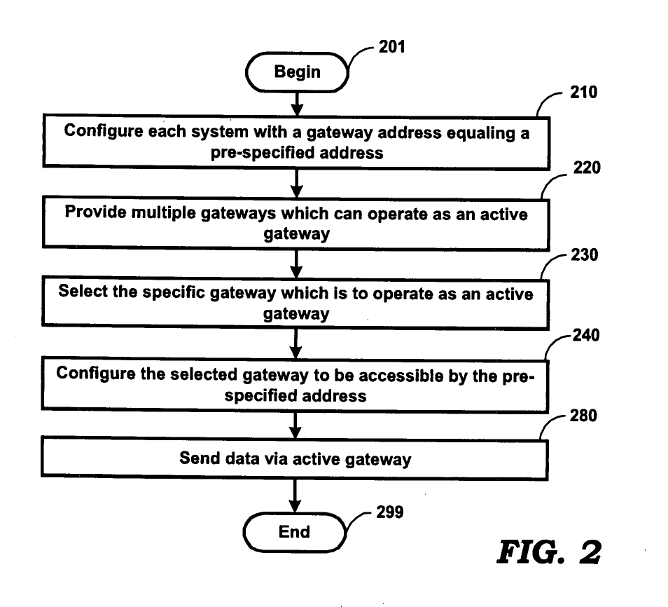

FIG. 2 is a flow-chart illustrating the manner in which connection establishment may be simplified in systems accessing other systems via redundant addressable gateways according to an aspect of the present invention. For illustration, the flow-chart is described with reference to FIG. 1, however, several aspects of the present invention may be employed in other environments as well. The method begins in step 201 in which control immediately passes to step 210.

In step 210, a user configures each system (e.g., client systems 180-A through 180-K, server systems 190-A and 190-B) with a gateway address equaling a pre-specified address. The configuration generally depends on the implementation of the system, and can be performed in a known way. In step 220, multiple gateways may be provide, with each gateway having the ability to operate as an active gateway. For example, each of gateways 150 and 160 may operate as an active gateway at a given time point, as described below in further detail.

In step 230, the specific gateway which is to operate as an active gateway is selected. In general, one of the gateways, which is usable/accessible needs to be selected as an active gateway. An example approach to selecting the active gateway and the manner in which an active gateway may be changed in case of failure of the active gateway, is described below. For illustration, it is assumed that gateway 150 is selected to operate as an active gateway.

In step 240, the specific gateway (150, in the illustrative example) determined to operate as an active gateway is configured to be accessible by the gateway address (configured in step 210). In several systems, the interface connecting to a network is configured to receive packets with the corresponding address. Configuration of the interface also depends on the specific environment (e.g., operating system) executing on the system, and may be implemented in a known way.

In step 280, each system sends data to other systems via active gateway (if gateway is needed in between) due to the configurations of steps 210 and 240. The data forms basis for establishing connectivity, as would be apparent to one skilled in the relevant arts. Control passes to step 299 in which the method ends.

Thus, in the example above, gateway 150 is described as operating as an active gateway. According to another aspect of the present invention, another one of the redundant gateways becomes the active gateway if a present active gateway becomes non-operational (not accessible) for whatever reason. The description is continued with reference to a manner in which gateway 160 starts operating as an active gateway according to an aspect of the present invention when a present active gateway 150 becomes non-accessible or non-operational.

### 4. Present Active Gateway Becomes Non-Operational

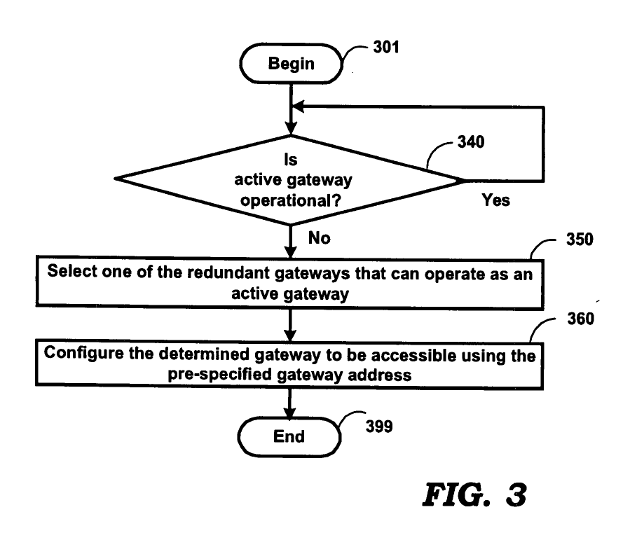

FIG. 3 is a flow-chart illustrating a manner in which another gateway automatically assumes the role of an active gateway if a present active gateway becomes non-operational. For illustration, the flow-chart is described with reference to FIGS. 1 and 2. However, the flow-chart can be used in other environments as well. The method begins in step 301 in which control immediately passes to step 310.

In step 340, a determination is made as to whether a present active gateway is operational. Various approaches (e.g., from external systems which attempt to connect through the active gateway, or internally generated commands to check the status of various hardware/software components) may be employed to determine whether the present active gateway is operational. Control passes to step 350 if connectivity is lost, otherwise to step 340.

In step 350, a specific redundant (backup) gateway that can operate as an active gateway is determined/selected. In general, any of the operational redundant gateways can be selected as the active gateway. An example approach to perform steps 340 and 350 is described below in further detail.

In step 360, the gateway selected in step 350 is configured with the pre-specified addresses (noted above in step 210) such that the selected gateway is reachable by the pre-specified address. As a result, systems contacting other systems via a gateway would communicate using the selected gateway without requiring any changes in the systems. The method ends in step 399.

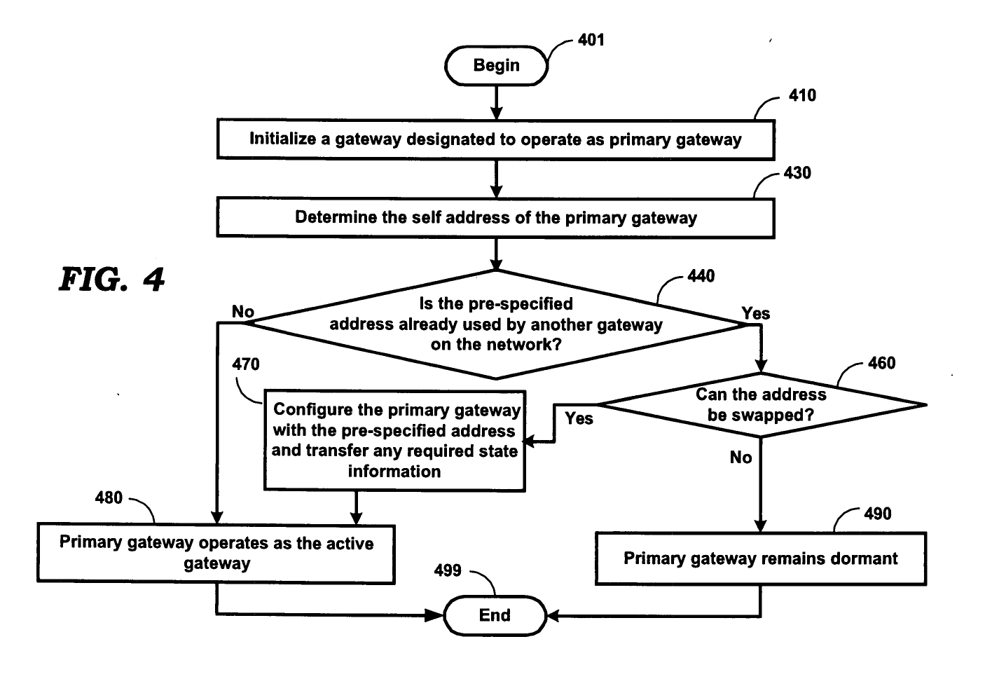

Thus, using the approach of FIG. 3, the active gateway may be changed to another one of the redundant systems if the present active gateway becomes non-operational. Given that any of the redundant systems can operate as an active gateway, it may be desirable to select one of gateways as an active gateway when the entire environment is initialized. The manner in which such a selection can be performed is described below with reference to FIG. 4.

### 5. Selecting Active Gateway During Initialization

According to an aspect of the present invention, one of the two gateways is configured as a default active (or primary) gateway and the other gateway is configured as a secondary gateway. In general, the specific gateway initializing first is designed to take on the role of the active gateway (by being configured with the pre-specified gateway address) and the remaining gateway may not be used for data forwarding. In addition, the primary gateway and the secondary gateway may engage in address swapping under certain conditions as described below with reference to FIG. 4.

FIG. 4 is a flow-chart illustrating the manner in which a primary (or default active) gateway may take on the role of an active gateway when initialized, in one embodiment of the present invention. For illustration, it is assumed that gateways 150 and 160 are respectively designated as primary and redundant gateways.

According to one convention implemented in the context of Bootp protocol (well known in the relevant arts), the primary gateway is configured with an odd device number and the secondary gateway is configured with the next higher even device number. The device number is generally added to a base address (even number) received from a bootp server (e.g., 190-B) to form the IP address for the gateway. Gateways 150 and 160 are respectively configured with odd (e.g., 3) and next higher even (e.g., 4) device index numbers consistent with the convention for primary and secondary gateways. The method begins in step 401 in which control immediately passes to step 410.

In step 410, the gateway designated to operate as a primary gateway, may be initialized. In the illustrative example, when gateway 150 (primary) is initialized, device index number may be read from an internal storage, e.g., from a registry using Windows (R) service routine in the case of Microsoft (R) product family. Thus, gateway 150 may read 3 as a corresponding device index number.

In step 430, primary gateway (150) determines the self address. For example, gateway 150 may send a Bootp request to server 190-B and may receive base address in response. Self address of primary gateway may be computed as equaling (base address+device number). Device number and base address are configured such that self address of primary gateway 150 equals pre-specified gateway address configured in each client systems 180-A through 180-K.

In step 440, primary gateway (150) determines whether the pre-specified gateway address is already being used by another gateway on the network. For example, gateway 150 may execute a ping command (ICMP echo request, well known in the relevant arts) with the pre-specified address to make such a determination. If a response is received, it may be determined that the pre-specified address is already in use. Alternatively, a custom protocol may be implemented on path 156 (e.g., using RS-232 serial protocol) to determine whether the secondary gateway is already using the pre-specified gateway address.

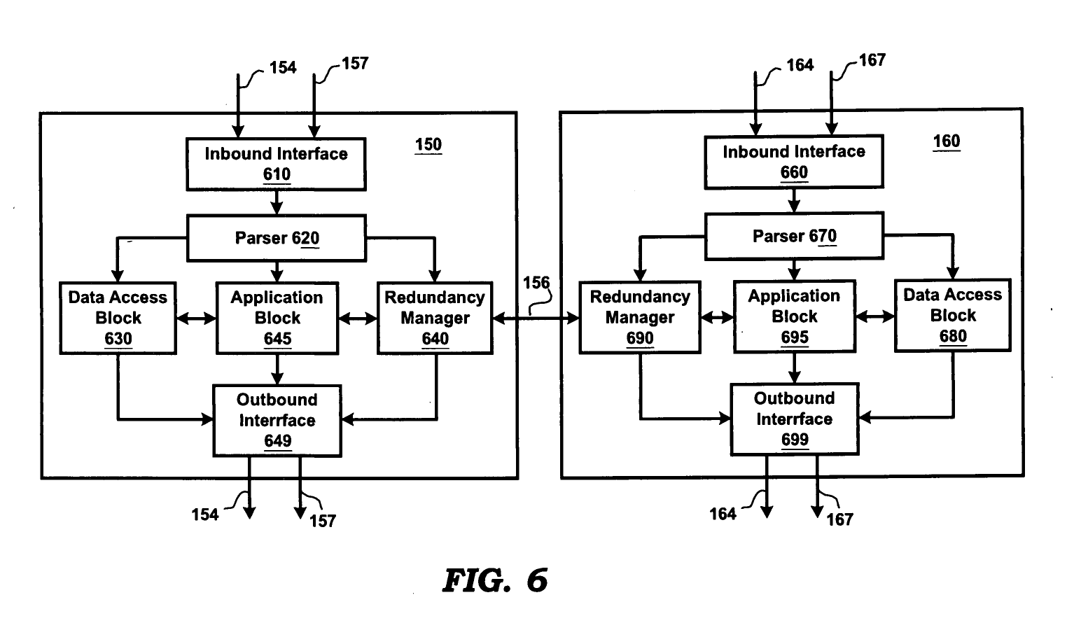

Control passes to step 460 if the pre-specified gateway address is already in use, otherwise to step 480. In step 460, gateway 150 determines whether the address can be swapped. In an embodiment, the pre-specified address configured with redundant (secondary) gateway can be swapped only if other applications (described below with reference to FIG. 6) are not initialized in gateway 160. Control passes to step 470 if the address can be swapped, otherwise to step 490.

In step 470, primary gateway (150) configures with the pre-specified address and any required state information (related to applications) may be transferred. In one embodiment, redundant gateway (160) drops the pre-specified address and takes on the address corresponding to the device number (i.e., an IP address corresponding to device number 4). Any data structures contained in redundant gateway (160) due to operation as an active gateway, may be transferred in response to a request sent by primary gateway (150). In step 480, primary gateway (150) operates as the active gateway and control passes to step 499.

In step 490, primary gateway (150) remains dormant. In other words, secondary gateway (160) continues to operate as active gateway, as pre-specified address is being used by secondary gateway (160). Control passes to step 499 in which the method ends.

Thus, primary gateway 150 may start to operate as an active gateway providing connectivity between various systems. The description is continued with reference to the manner in which gateway 160 may operate as an active gateway when initialized.

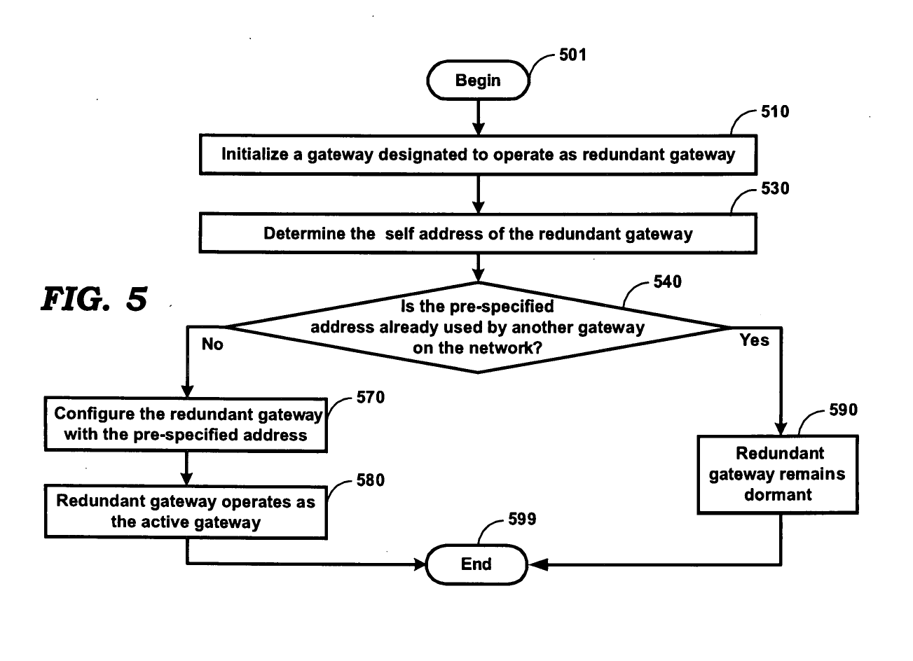

FIG. 5 is a flow-chart illustrating the manner in which a secondary (or default secondary) gateway may take on the role of an active gateway when initialized, in one embodiment of the present invention. The method begins in step 501 in which control immediately passes to step 510.

In step 520, a gateway designated to operate as secondary gateway (160) may be initialized (ahead of gateway 150 designated as primary gateway). In step 530, secondary gateway 160 determines the self address by computing the sum of base address and corresponding device number. Base address may be received (in response to the request sent) from server system 190-B. Self address is determined in a manner similar to computations described in step 430 with reference to gateway 150.

In step 540, secondary gateway (160) determines whether the pre_specified address is already used by another gateway on the network. For example, gateway 160 may execute a ping command (ICMP echo request, well known in the relevant arts) with the pre-specified address or a custom protocol may be used to make such a determination, similar to step 440. Control passes to step 590 if another system is already using the pre-specified address, otherwise to step 570.

In step 590, secondary gateway 160 may remain dormant (i.e., gateway 160 may continue to operate as a secondary system as desired by a user). Control passes to step 499 in which the method ends.

In step 570, secondary gateway (160) configured to be accessible with the pre-specified address. Gateway 160 drops the self address corresponding to a device number (4) and configures with the pre-specified address. Configuring and dropping of address(es) generally depends on the specific operating system used on the gateway, and may be implemented in a known way. In step 580, secondary gateway (160) operates as the active gateway. Control passes to step 599 in which the method ends.

Thus, gateway 160 may operate as an active gateway. The description is continued with reference to an embodiment in which gateways 150 and 160 communicate to determine the role of an active gateway.

### 6. Embodiment of Gateway

FIG. 6 is a block diagram illustrating the details of gateway 150 and 160 in one embodiment. Gateway 150 is shown containing inbound port 610, parser 620, data access block 630, redundancy manager 640, application block 645 and outbound interface 649. Gateway 160 is shown containing inbound port 660, parser 670, data access block 680, redundancy manager 690, application block 695 and outbound interface 699. Various blocks of gateway 160 may be implemented similar to corresponding blocks contained in gateway 150 and only blocks contained in gateway 150 are described below for conciseness.

Inbound interface 610 provides the electrical, physical, and protocol interfaces to receive packets from different client systems (on path 157) and traffic controller 140 (on path 154). The received packets are forwarded to parser 620.

Similarly, outbound interface 649 provides the electrical, physical, and protocol interfaces to send packets to various client systems and traffic controller 140. Both inbound interface 610 and outbound interface 649 may be implemented in a known way.

Parser 620 examines each received packet and forwards the received packet to one of data access block 630, redundancy manager 640, and application block 645.

The specific block to forward to depends generally on the header contents (e.g., protocol, port number, etc.) of each received packet. Parser 620 may be implemented in a known way.

Data access block 630 listens to commands on various ports, and initiates (starts execution of) application block 645 to process the commands. Further, the commands (sent by client systems) are forwarded to application block 645, and the data (collected form field devices) received from application block 645 may be sent on outbound interface 649. For example, a command (from operator using client system 180-B) seeking input parameter value of field device 110-A may be forwarded to application block 645 and corresponding response (received from application block 645) may be forwarded to client system 180-B using outbound interface 649.

Application block 645 communicates with field devices via control (e.g., 130-A) and I/O blocks (e.g., 120-A) in response to receiving commands from data access block 630, and receives data packets representing process parameters. The data packets may be forwarded to data access block 630. Specific data from a corresponding device may be received/collected based on the command/request received from data access block 630. Application block 645 may also acknowledge (indicating the operating status) messages that may be periodically sent by redundancy manager 640. Application block 645 may perform various tasks to support a manufacturing process, and may be implemented in a known way depending the requirements of the specific environment.

Redundancy Manager 640 determines whether gateway 150 can operate as a primary gateway as noted in step 230. Such determination is based on determining the self address, and examining whether another system with the same address is already connected to the network 175 or not as described in steps 430 and 440. Once a redundancy manager determines that gateway 150 can operate as a gateway, the pre-specified address may be configured as described in step 470.

When not operating as a primary gateway, redundancy manager 640 may interface with redundancy manager 690 to determine whether gateway 160 (which should be operating as a primary gateway) is operational. The operational status may be determined by exchanging heartbeat type of messages periodically. Such messages may be exchanged using a serial communication path (156) or any other appropriate communication approaches as will be apparent to one skilled in the relevant arts. If gateway 160 is not operational, redundancy manager 640 may operate to cause gateway 150 as the primary gateway by appropriate reconfiguration (e.g., configuring an interface with the pre-specified gateway address and transferring application block information to the extent possible).

When operating as a primary gateway, redundancy manager 640 may periodically send heartbeat messages on path 156 indicating the operational status of gateway 150. Heartbeats may be similarly received from the redundancy manager in the other system. Redundancy manager 640 may further check whether application block 645 and data access block 630 are operational before sending the heartbeat messages. Various type of protocols may be implemented between redundancy managers 640 and 690 to communicate/check the operational status of the gateways, as will be apparent to one skilled in the relevant arts by reading the disclosure provided herein.

Thus, various blocks may be designed to operate cooperatively to implement several aspects of the present invention. The description is continued with reference to implementation of gateway 150 and 160 implemented substantially in the form of software.

### 7. Software Implementation

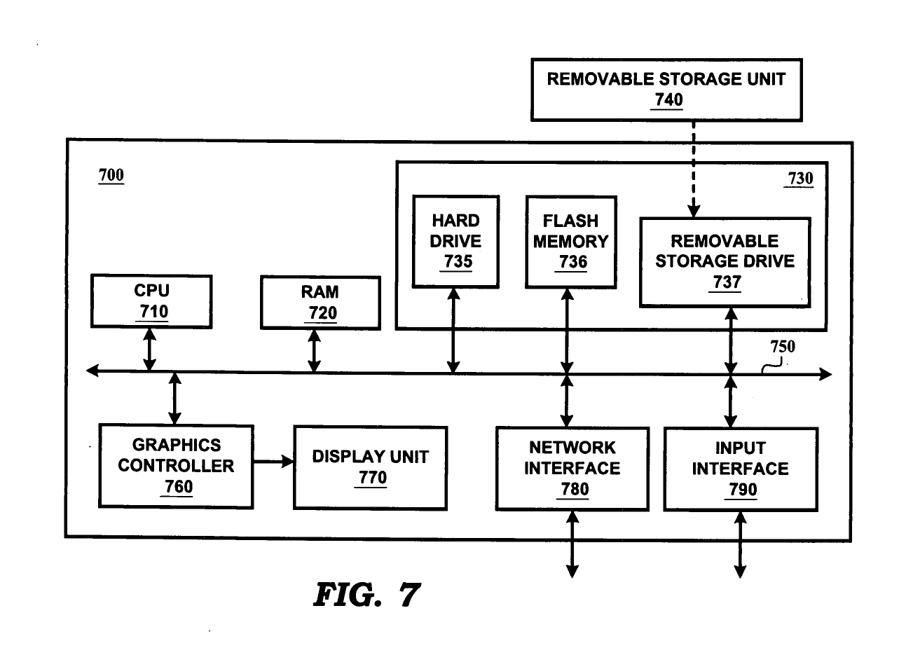

FIG. 7 is a block diagram illustrating the details of digital gateway 700 representing gateway 150, and/or 160 implemented substantially in the form of software in an embodiment of the present invention. System 700 may contain one or more processors such as central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present invention. CPU 710 may contain multiple processing units, with each processing unit potentially being designed for a specific task. Alternatively, CPU 710 may contain only a single general purpose processing unit. RAM 720 may receive instructions from secondary memory 730 using communication path 750. The instructions may determine a gateway that can operate as an active gateway, configure the (active) gateway to be accessible by the pre-specified address, etc., as described in sections above.

Graphics controller 760 generates display signals (e.g., in RGB format) to display unit 770 based on data/instructions received from CPU 710. Display unit 770 contains a display screen to display the images defined by the display signals. Input interface 790 may correspond to a key_board and/or mouse.

Secondary memory 730 may contain hard drive 735, flash memory 736 and removable storage drive 737. Secondary memory 730 may store the data and software instructions (e.g., pre-specified address, APIs etc.) which enable system 700 to provide several features in accordance with the present invention. Some or all of the data and instructions may be provided on removable storage unit 740, and the data and instructions may be read and provided by removable storage drive 737 to CPU 710. Floppy drive, magnetic tape drive, CD_ROM drive, DVD Drive, Flash memory, removable memory chip (PCMCIA Card, EPROM) are examples of such removable storage drive 737.

Removable storage unit 740 may be implemented using medium and storage formatcompatible with removable storage drive 737 such that removable storage drive 737 can read the data and instructions. Thus, removable storage unit 740 includes a computer readable storage medium having stored therein computer software and/or data.

In this document, the term “computer program product” is used to generally refer toremovable storage unit 740 or hard disk installed in hard drive 735. These computer program products are means for providing software to system 700. CPU 710 may retrieve the software instructions, and execute the instructions to provide various features of the present invention as described above.

### 8. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

1. A method of simplifying implementation of a first system accessing a plurality of systems via an active gateway, wherein said active gateway corresponds to any one of a plurality of redundant gateways, said method comprising:
configuring said first system to communicate with said active gateway using a pre-specified address;
selecting a specific gateway from said plurality of redundant gateways to operate as said active gateway; and
configuring said specific gateway to be accessible by said pre_specified address.

2. The method of claim 1, further comprising:
determining whether said specific gateway is operational;
selecting another one of said plurality of redundant gateways as said active gateway if said specific gateway is not operational; and
configuring said another one of said plurality of redundant gateways to be accessible by said pre-specified address.

3. The method of claim 2, wherein said determining comprises sending to said specific gateway a heartbeat message periodically, and determining that said specific gateway is operational if a response is received for said heartbeat message.

4. The method of claim 1, wherein said selecting comprising:
checking at a time of initialization of each of said plurality of redundant gateway whether said pre-specified address is already in use; and
configuring the redundant gateway as said active gateway if said pre-specified address is already not used, otherwise, remaining dormant.

5. The method of claim 4, further comprising:
reading a corresponding device number when each of said plurality of gateways are initialized;
receiving a base address in response to a request sent to a server; and
computing a self address as equaling said base address plus said device number.

6. The method of claim 4, wherein said checking comprising:
executing a ping command with said pre-specified address;
examining a response to said ping command; and
deciding that said pre-specified address is already used if said response contains pre-specified address, otherwise deciding that pre-specified address is not used.

7. The method of claim 4, wherein said plurality of redundant gateways comprise a primary gateway designated to operate as a default active gateway and a secondary gateway designated to operate as a default redundant gateway, wherein said checking is performed in said primary gateway and it is determined that said pre-specified address is already in use, said method further comprising:
determining whether said pre-specified address can be swapped; and
configuring said primary gateway to be accessible by said pre-specified address if said pre-specified address can be swapped.

8. The method of claim 7, wherein said method is implemented in a manufacturing plan and said first system comprises a client system and each of said plurality of systems comprise one of a field device and control device.

9. A networking environment comprising:
a plurality of systems;
a first system to communicate with an active gateway using a pre-specified address to communicate with each of said plurality of systems; and
a plurality of redundant gateways, wherein any of said plurality of redundant gateways selected to operate as said active gateway is configured to be accessible by said pre_specified address.

10. The networking environment of claim 9, wherein said plurality of gateways are operable to:
determine whether said active gateway is operational;
select another one of said plurality of redundant gateways as said active gateway if said active gateway is not operational; and
configure said another one of said plurality of redundant gateways to be accessible by said pre-specified address.

11. The networking environment of claim 10, wherein said determine is performed by sending to said active gateway a heartbeat message periodically, and concluding that said active gateway is operational if a response is received for said heartbeat message.

12. The networking environment of claim 9, wherein said select is performed by:
checking at a time of initialization of each of said plurality of redundant gateway whether said pre-specified address is already in use; and
configuring the redundant gateway as said active gateway if said pre-specified address is already not used, otherwise, remaining dormant.

13. The networking environment of claim 12, wherein said plurality of redundant gateways comprise a primary gateway designated to operate as a default active gateway and a secondary gateway designated to operate as a default redundant gateway, wherein said checking is performed in said primary gateway and it is determined that said pre-specified address is already in use, said primary gateway is operable to:
determine whether said pre-specified address can be swapped; and
configure said primary gateway to be accessible by said pre-specified address if said pre-specified address can be swapped.

14. The networking environment of claim 13, wherein said first system comprises a client system and each of said plurality of systems comprise one of a field device and control device.

15. computer readable medium carrying one or more sequences of instructions for causing each of a plurality of redundant gateway to simplifying implementation of a first system accessing a plurality of systems via an active gateway, wherein said active gateway corresponds to any one of a plurality of redundant gateways, wherein execution of said one or more sequences of instructions by one or more processors causes said one or more processors to perform the actions of:
configuring any of said plurality of redundant gateways selected as said active gateway to be accessible by said pre_specified address,
whereby said first system can access said plurality of systems by using only said pre-specified address to communicate via said active gateway.

16. The computer readable medium of claim 15, further comprising:
determining whether said active gateway is operational;
selecting another one of said plurality of redundant gateways as said active gateway if said active gateway is not operational; and
configuring said another one of said plurality of redundant gateways to be accessible by said pre-specified address.

17. The computer readable medium of claim 16, wherein said determining comprises sending to said active gateway a heartbeat message periodically, and determining that said active gateway is operational if a response is received for said heartbeat message.

18. The computer readable medium of claim 15, wherein said selecting comprising:
checking at a time of initialization of each of said plurality of redundant gateway whether said pre-specified address is already in use; and
configuring the redundant gateway as said active gateway if said pre-specified address is already not used, otherwise, remaining dormant.

19. The computer readable medium of claim 18, further comprising:
reading a corresponding device number when each of said plurality of gateways are initialized;
receiving a base address in response to a request sent to a server; and
computing a self address as equaling said base address plus said device number.

20. The computer readable medium of claim 18, wherein said checking comprising:
executing a ping command with said pre-specified address;
examining a response to said ping command; and
deciding that said pre-specified address is already used if said response contains pre-specified address, otherwise deciding that pre-specified address is not used.

21. The computer readable medium of claim 18, wherein said plurality of redundant gateways comprise a primary gateway designated to operate as a default active gateway and a secondary gateway designated to operate as a default redundant gateway, wherein said checking is performed in said primary gateway and it is determined that said pre-specified address is already in use, further comprising:
determining whether said pre-specified address can be swapped; and
configuring said primary gateway to be accessible by said pre-specified address if said pre-specified address can be swapped.
